(19) United States
(12) Patent Application Publication
(10) Pub. No.: US 2024/0389523 A1
(43) Pub. Date: Nov. 28, 2024

(54) WEATHER MANAGEMENT SYSTEM

(71) Applicant: Toyota Motor Engineering & Manufacturing North America, Inc., Plano, TX (US)

(72) Inventors: Shailesh N. Joshi, Ann Arbor, MI (US); Taewoo Nam, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/200,644

(22) Filed: May 23, 2023

(51) Int. Cl. A01G 15/00; B64B 1/66

(52) U.S. Cl. CPC A01G 15/00; B64B 1/66

(57) ABSTRACT

Various embodiments of a weather management system launch an aerial feature to an elevation while the aerial feature is tethered to a positioning system. The positioning system generates a motion strategy to direct aerial feature movement over time to induce a surface condition selected by the positioning system. Execution of the motion strategy over time with the positioning system steers the aerial feature to react with naturally occurring weather conditions to provide the selected surface condition.

### TECHNICAL FIELD

The subject matter described herein relates, in general, to management of naturally occurring conditions and, more particularly, to harvesting or manipulating weather to provide human benefits.

### BACKGROUND

Monitoring weather phenomenon has occurred for centuries. Harnessing the naturally occurring forces and energy of weather conditions has aided human growth and sophistication through agriculture, electricity, and water management. However, expansion of human population and changing climatological patterns has created challenges to efficiently supply modern civilization with sufficient resources to continue to grow and thrive. For instance, conventional methods of reacting to natural phenomenon can be insufficient and/or inefficient to harness water for agriculture and human consumption. Hence, there is a continued goal to increase the ability to influence and harness weather conditions, particularly for the production and management of water.

### SUMMARY

Example weather management systems generally relate to a manner of improving the handling and harnessing of naturally occurring weather conditions.

In one embodiment, a weather management system has an aerial feature tethered to a positioning system that steers the aerial feature to position the aerial feature to react to naturally occurring weather conditions to alter surface conditions. Generation and execution of a strategy by the positioning system positions the aerial feature to perform at least the seeding of a cloud, generation of shade on a predetermined surface location, or collection of water from the atmosphere.

A weather management system can be operated, in some embodiments, to launch an aerial feature to an elevation while the aerial feature is tethered to a positioning system. The positioning system generates a motion strategy to direct aerial feature movement over time to induce a surface condition selected by the positioning system. Execution of the motion strategy over time with the positioning system steers the aerial feature to react with naturally occurring weather conditions to provide the selected surface condition.

Utilization of a weather management system in accordance with other embodiments launch an aerial feature including a first lift member and a second lift member with each lift member tethered to a positioning system. The positioning system generates a motion strategy to direct movement of first lift member over time to induce a first surface condition and movement of the second lift member over time to induce a second surface condition that is different from the first surface condition. Execution of the motion strategy over time with the positioning system steers the respective lift members to position the aerial feature to react with naturally occurring weather conditions to provide the first surface condition and second surface condition concurrently.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block representation of an environment in which assorted embodiments and methods disclosed herein may be implemented.

FIG. 2 illustrates portions of an example weather management system capable of being used in the environment of FIG. 1.

FIG. 3 illustrates a block representation of portions of an example weather management system configured in accordance with some embodiments.

FIG. 4 illustrates portions of an example weather management system arranged in accordance with assorted embodiments.

FIG. 5 illustrates portions of an example weather management system configured in accordance with various embodiments.

FIG. 6 illustrates portions of an example weather management system arranged in accordance with some embodiments.

FIG. 7 illustrates portions of an example weather environment in which assorted embodiments of a weather management system can be employed.

FIG. 8 illustrates a block representation of an example positioning system that can be utilized as part of a weather management system in various embodiments.

FIG. 9 illustrates a flowchart of an example management routine that can be carried out to optimize weather manipulation in accordance with assorted embodiments.

### DETAILED DESCRIPTION

Systems, methods, and other embodiments associated with improving the management of naturally occurring weather conditions are disclosed herein. As previously described, conventional weather management can be insufficient and/or inefficient to provide resources for modern human civilization.

Accordingly, various embodiments of a weather management system are directed to manipulating weather conditions to optimize the efficiency and supply of natural resources. The use of one or more aerial features can harvest wind for electricity, water for human consumption, and/or provide shade for select regions of the earth. Intelligent construction and operation of an aerial feature can promote weather conditions and the production of liquid water that can be subsequently harvested for later use. Other embodiments can concurrently utilize multiple aerial features to manipulate weather conditions at different elevations of the atmosphere, which can provide efficient manipulation of naturally occurring phenomenon while harvesting resources from other naturally occurring phenomenon.

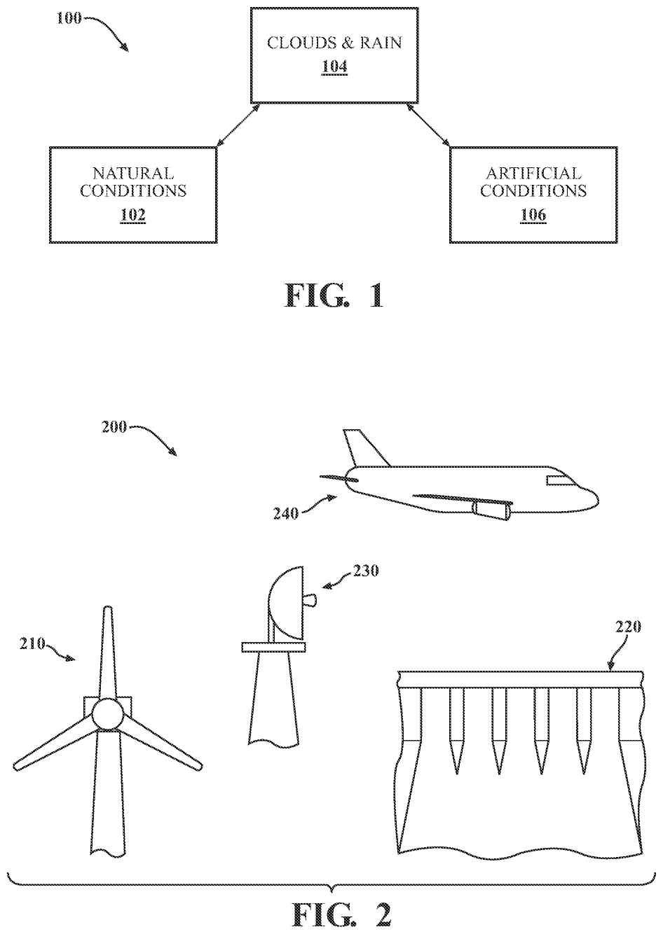

With reference to FIG. 1, an example environment 100 is illustrated in which assorted embodiments of a weather management system can be practiced. The environment 100 can include any number and type of natural conditions that contribute to the presence of at least clouds and rain 104. That is, naturally occurring phenomenon, such as water vapor, humidity, barometric pressure, and wind, can influence the development, growth, strength, and location of clouds, which can produce rain that can fall to the ground as a liquid, solid, or combination of the two.

The formation and proliferation of clouds and rain 104 can also be influenced by artificial conditions 106 that are not naturally occurring at a particular location. For instance, heat from large areas of concrete can contribute to the development of, or mitigation of, clouds that produce rain. Another example of artificial conditions 106 is cloud seeding with particles that promote the collection of water vapor into rain producing clouds. Such artificial conditions 106 can, theoretically, increase rainfall in areas that need water or cause dangerous clouds to release energy in selected areas that reduce harm to humans and/or man-made structures. The ability to harness natural conditions 102 and artificial conditions 106 to influence clouds and rain 104 can provide enhanced shade and water management. However, existing mechanisms to forecast and/or influence cloud formation can be inconsistent and inefficient, particularly in certain topographical regions of the world.

FIG. 2 illustrates portions of an example weather management system 200 arranged in accordance with various embodiments to operate in the environment 100 of FIG. 1. The weather management system 200 can utilize any number and type of assemblies to influence and/or harness existing weather and weather-related elements. As a non-limiting example, a wind turbine 210 can respond to moving air by generating electricity that can be stored or immediately employed to power downstream devices. Similarly, moving water can be harnessed by a dam 220 to generate electricity. The harnessing of naturally occurring phenomenon, such as wind, rivers, and lakes, can provide valuable resources for human consumption. However, the function of such resource harnessing mechanisms is jeopardized by weather conditions, such as drought, lightning, or extreme wind speeds.

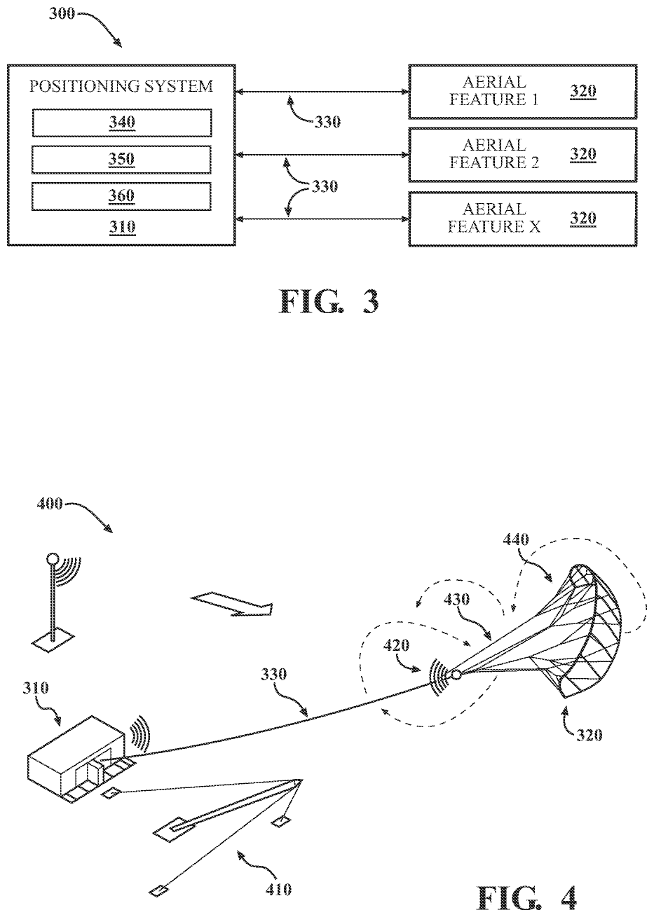

FIG. 3 illustrates a block representation of portions of an example weather management system 300 that can operate alone in the environment 100 of FIG. 1 or in combination with the assorted aspects of the system 200 of FIG. 2. As shown, a positioning system 310 can interact with any number (X) of aerial feature 320, which can be any unpowered structure or assembly that exhibits flight capabilities and characteristics. For instance, an aerial feature 320 may be a kite, airfoil, or wing that generates lift force in response to moving air. The unpowered configuration of the respective aerial features 320 can be accommodated by one or more tethers 330 that physically connect the positioning system 310 to each feature 320. The tethered arrangement allows the positioning system 310 to direct the position, motion, and activity of the respective aerial features 320.

In some embodiments, the positioning system 310 can generate one or more strategies that proactively prescribe aerial feature 320 activity to provide predetermined results, such as electricity generation, water formation, water harvesting, and ground shade production. A positioning system 310 strategy may be generated and/or executed by a local system processor 340. That is, the processor 340 may create a strategy from scratch, modify an existing strategy stored in local memory 350, and execute a strategy created elsewhere and stored in the local memory 350. The ability to execute strategies that are created locally with the processor 340 or remotely before being downloaded to local memory 350 allows the positioning system 310 to maximize operational efficiency during dynamic environmental conditions, such as changing wind, clouds, humidity, and barometric pressure.

The operation of the positioning system 310 can involve executing a strategy based on various triggers. For instance, the system processor 340 may carry out some, or all, of a strategy stored in local memory 350 in response to a predetermined time and/or condition detected by one or more sensors 360. It is noted that detected conditions can be identified from any number and type of sensor 360 that is physically located anywhere relative to the positioning system 310, such as on the positioning system 310, on an aerial feature 320, on a tether 330, or positioned external to any aspect of the weather management system 300.

FIG. 4 illustrates portions of a weather management system 400 configured in accordance with some embodiments to engage various environmental conditions. Although not required or limiting, the system 400 shown in FIG. 4 utilizes a single positioning system 310 to control a single aerial kite feature 320 via a single tether 330. The kite feature 320 can remain airborne by creating lift force in response to wind that is monitored by one or more external wind meters, as shown.

The positioning system 310 can employ a ground station 410 to aid in kite feature 320 launching and retrieval by locating the feature 320 in a position promoting lift generation for launching and stability for kite feature 320 landing. The aerial kite feature 320 can be fitted with one or more sensors and/or computing devices 420 that can communicate assorted information to at least the positioning system 310. That is, a device 420 containing circuitry that measures conditions, such as position, elevation, motion, and humidity, prior to sending the collected data to the positioning system 310 for interpretation and optimization of aerial feature 320 activity. The feature computing device 420 may, in some embodiments, have communication circuitry capable of sending two-way communication. The computing device 420 may have local wired and/or wireless communication with one or more feature sensors 430 mounted on one or more bridle lines 440 of the aerial kite feature 320.

It is contemplated that the aerial kite feature 320 has motion and elevation above the positioning system 310 dictated by a strategy stored in memory of the system 310. As displayed by segmented lines, motion of the aerial kite feature 320 can be controlled by the positioning system 310 to promote one or more weather management themes, such as electricity generation, cloud seeding, or water harvesting. The operation of the various aspects of the positioning system 310, such as the power electronics, battery module, control center, and generator module, can provide directed aerial kite feature 320 motion at prescribed elevations that promote manipulation of weather and/or weather conditions to provide a practical benefit, such as generating electricity, harvesting water, producing shade, and forming clouds.

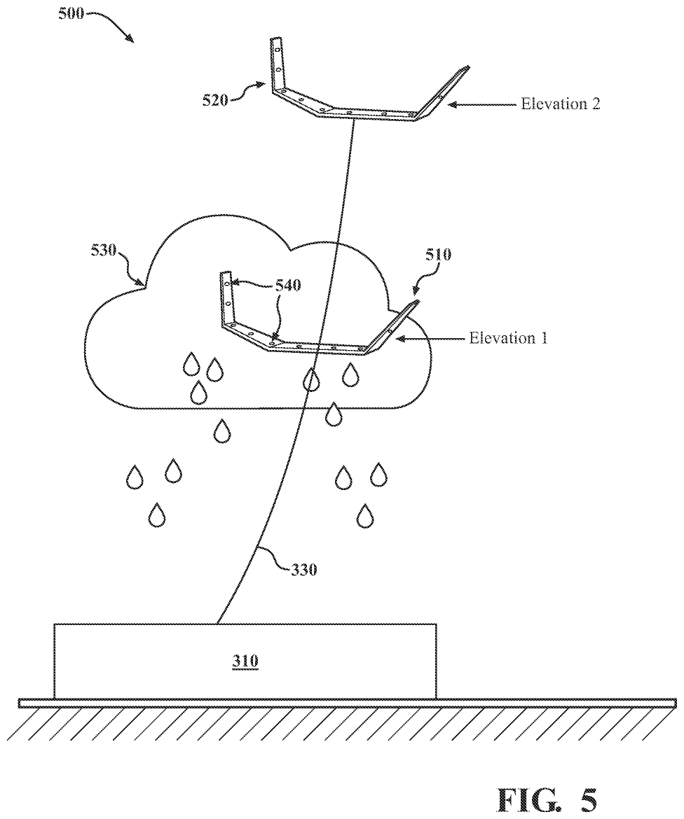

FIG. 5 illustrates portions of another example weather management system 500 arranged to carry out assorted embodiments to engage and harness environmental conditions. While some embodiments utilize a single positioning system 310 to control a single aerial feature, other embodiments physically tether multiple separate aerial features to a single positioning system 310. The ability to vertically stack multiple aerial features on a single tether 330 allows a single positioning system 310 to provide redundant and/or concurrently different weather management themes to alter surface conditions with electricity, water, shade, or a combination thereof.

In the non-limiting example of FIG. 5, a first aerial feature 510 is positioned at a first elevation above a surface while a second aerial feature 520 is positioned at a second elevation above a surface, such as the ground or water surface of a lake or ocean. The first aerial feature 510 is configured to promote the transition of atmospheric water vapor into clouds 530 by presenting multiple separate seeding nodes 540. Although not required, the seeding nodes 540 can each be a solid form of a common material, such as silver iodide or salt. Other embodiments arrange the respective seeding nodes 540 as different phases, such as liquid or solid, as well as different materials that can increase the chance of cloud formation in a manner that generates rainfall that reaches the ground or body of water. The seeding nodes 540 can be positioned on any surface of the aerial feature 510 and constructed with any shape/size, such as circular, semi-circular, rhomboid, or a combination of linear and curvilinear surfaces.

The promotion of cloud formation at the first elevation can be conducted while the second aerial feature 520 generates electricity and/or produces shade for select portions of an underlying surface, such as the ground or a body of water. That is, the second aerial feature 520 can engage in movement directed by the positioning system 310 to generate electricity in a generator of the positioning system 310, to shade selected regions below, or harvest water vapor through condensation atop the surface of the aerial feature 520. It is noted that the second aerial feature 520 can be used alone to steer the tether 330 and first aerial feature 510 while other embodiments use feature steering configurations in both features 510/520 to direct movement of the collective tether 330.

The harvesting of water vapor can complement cloud seeding by allowing the collection of water both at the positioning system 310 and at other surface regions where rainfall is collected. The ability to customize the elevation, motion, and configuration of multiple separate aerial features 510/520 can optimize weather management efficiency and the practical alteration of underlying surface conditions either from cloud cover, shade, rainfall, or dispensing of harvested water. The efficient collection of water vapor with an aerial feature allows for the harvesting of water in conditions that are unlikely to produce rain-producing clouds via seeding.

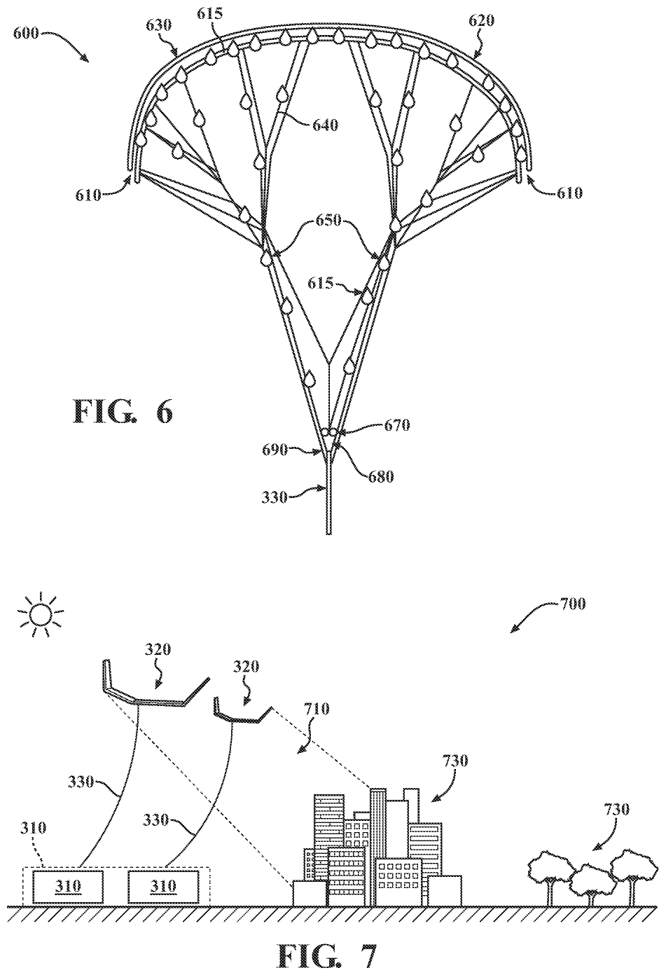

FIG. 6 illustrates portions of an example aerial feature 600 that can be connected to a positioning system 310 via a tether 330 as part of a weather management system. The aerial feature 600 has a continuous canopy 610 that has a rigidity provided by strut tubes 620 positioned along a safety line 630. That is, placement and size of strut tubes 620 along the length of the canopy 610 provides a predetermined cross-sectional shape that is conducive to producing lift forces in response to air traveling across the canopy 610 and safety line 630. It is contemplated that the strut tubes 620 aid in directing water that has condensed on the canopy to bridle lines 640 that guide the water towards the tether 330, as illustrated by the water droplets 615.

Motion of the aerial feature 600 can be facilitated by one or more steering lines 650 that control portions of the canopy 610 to generate lift force and/or manipulate how the canopy 610 moves in response to wind. Various embodiments of the aerial feature 600 incorporate one or more computing devices into the canopy 610. For instance, circuitry of the computing device, such as an inertial management unit (IMU) and/or global positioning sensor (GPS), can have electoral energy supplied by one or more power lines 660. It is noted that a power line 660 may provide a data pathway for signal communication between computing circuitry of the aerial feature 600 and the connected positioning device.

While motion and lift can be manipulated by any pressure applied to one or more steering lines 650, electrically activated mechanisms can carry out choreographed aerial feature 600 motion over time. As a non-limiting example, a depower winch 670 can operate to tilt the canopy 610 upon activation to reduce lift and aid in reducing tension on the tether 330 and connected positioning system. A steering winch 680 can complement or replace the depower winch 670 by allowing mechanized application of pressure on the respective steering lines 650. The use of electrically powered motors for the respective winches 670/680 can allow precise and efficient aerial feature 600 motion to carry out a positioning system strategy, such as a water harvesting strategy, cloud seeding strategy, electricity generation strategy, or shade strategy.

The execution of a predetermined motion strategy for the aerial feature 600 can involve activation, and manipulation over time, of the respective feature winches 670/680 by the positioning system alone. However, some embodiments utilize a local feature control unit 690 to direct activity of the respective feature winches 670/680 and carry out a predetermined strategy. That is, a local control unit 690 can have electrical circuitry that executes translates strategy instructions from a positioning system into electrical activity of at least one winch 670/680 to produce selected feature 600 motion, lift, and weather management themes. It is contemplated that the local feature control unit 690 can be connected to one or more local sensors, such as a pressure, acoustic, optical, or mechanical detector, that provides condition and status information that allows the control unit 690 to maintain desired motion and position despite dynamic wind, pressure, and humidity conditions aloft.

The physical control and manipulation of the aerial feature 600 by the various mechanisms, along with the resulting feature movement, can promote the condensation of water vapor into liquid water on the surface of the canopy 610 and flow of the liquid water to the hollow tether 330, as conveyed by the water droplets 615. That is, the control unit 690 can conduct aerial feature 600 movement to promote condensation on the canopy 610, flow liquid water down the bridle lines 640, collect liquid water at the tether 330, and push liquid water towards a reservoir proximal to the ground-based positioning system. It is noted that the various bridle lines 640 can form various joints that promote the collection of liquid water as well as the matriculation of that water towards the single tether 330. It is contemplated that various surfaces, lines, and joints of the aerial feature 600 can be constructed of a material, or coated with a material, that promotes liquid movement with minimal loss of volume.

Through the efficient harvesting of liquid water with the aerial feature 600, water vapor that is insufficient to form a cloud via cloud seeding can be utilized to produce water in volumes that can be collected in a reservoir. In some embodiments, a single aerial feature 600 can be employed to harvest water from atmospheric water vapor present at one or more elevations above an underlying surface. Other embodiments can employ a number of separate aerial features 600 to harvest liquid water from different locations and/or elevations concurrently. The ability to utilize separate aerial features 600 redundantly or to provide concurrent different weather management themes, such as electricity generation, shade generation, or cloud seeding, allows for efficient multi-tasking weather management that can result in separate surface condition alterations.

FIG. 7 illustrates portions of an example weather environment 700 in which assorted embodiments of a weather management system can be practiced. In the non-limiting example embodiment shown in FIG. 7, multiple separate aerial features 320 are concurrently employed provide a common weather management theme of shade 710. The respective aerial features 320 can be connected to separate positioning systems 310, in some embodiments, while other embodiments utilize separate tethers 330 to control the separate aerial features 320 from a single positioning system 310, as conveyed by segmented box 310.

An aerial feature 320 can be configured in a variety of different sizes, shapes, and capabilities that allow a positioning system 310 to provide a predetermined amount of shade 710 at a selected portion of an underlying surface, such as the ground, or body of water. While not limiting, various embodiments of the shade-providing aerial feature 320 provide a kite configuration that produces lift forces in response to moving air. Such a kite configuration can allow for unpowered production of shade, controllable shade, and production of electricity without degrading the circadian rhythms of people being shaded from the sun.

Through the intelligent movement of an aerial feature 320, lift forces are produced to maintain the elevation of the feature 320 above an underlying surface while providing dynamic shade 710 for selected surface regions. Construction of an aerial feature 320 can position reflective surfaces to repel visible and/or non-visible wavelengths. It is noted that the movement of an aerial feature 320 contrasts a static shading of a surface region. That is, providing constant shade to a surface region for an extended period of time can disrupt the natural rhythm for humans and/or agriculture 720. With these issues in mind, embodiments of a positioning system 310 move one or more aerial features 320 according to a predetermined shade strategy in order to lower the surface temperature without degrading the circadian rhythms of shaded humans in cities 730 or energy production in plants.

The strategic movement of aerial features 320 may involve dynamic aspects of the feature 320 itself. For instance, portions of an aerial feature 320 can move, extend, articulate, or otherwise change in response to electrical, hydraulic, pressurized pneumatic, or unpressurized air to provide evolving shade 710 shapes, intensities, and/or sizes that lower surface temperature without interfering with naturally occurring responses to sunlight in at least humans and plants. Shade 710 can be provided by multiple separate aerial features 320 to lower surface temperatures without concern for physical interference or redundant shade 710 production via the execution of a collective shade strategy. That is, carrying out prescribed motion and/or elevation parameters for multiple separate aerial features 320 can provide intelligent shade that changes over time to allow some sunlight to reach the underlying surface without raising surface temperatures or resulting in impact between the respective features 320.

Various embodiments of a shade strategy utilize one or more sensed environmental conditions to determine how to provide intelligent shade to select surface regions. As such, a positioning system 310 can employ data collected from any number, and type, of sensors positioned on the ground, on an aerial feature 320, or in the positioning system 310 to adapt between feature 320 motion prescribed within a single shade strategy. The ability to react to sensed environmental information by altering aerial feature 320 movement can allow for intelligent shade 710 without concern for changing weather, ground, body of water, or feature 320 conditions.

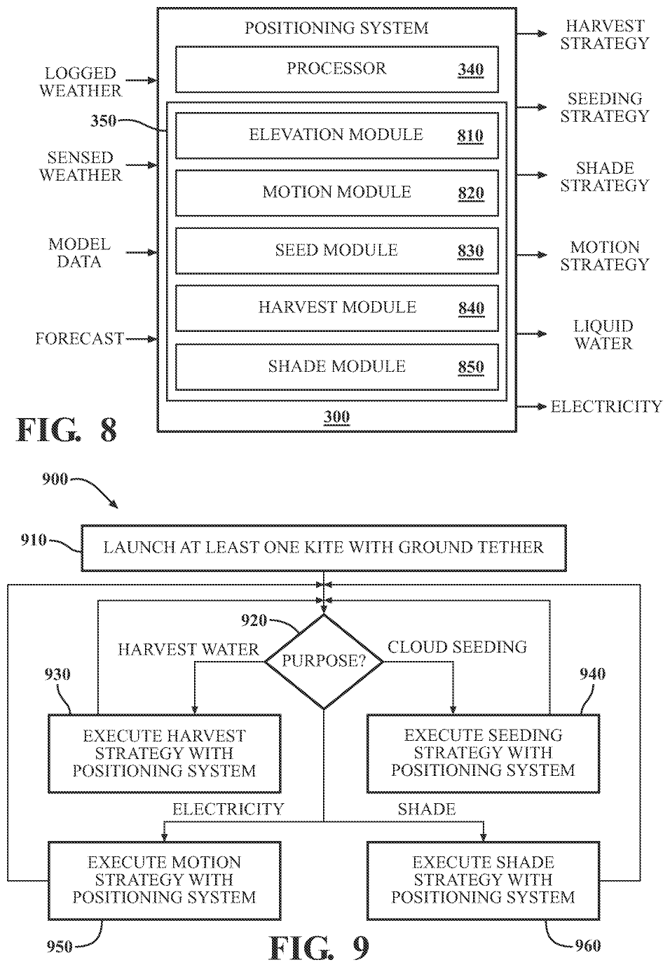

FIG. 8 illustrates a block representation of an example positioning system 310 that can be employed as part of the weather management system of FIGS. 2-6 in accordance with assorted embodiments. As conveyed in the various environments discussed above, a positioning system 310 can provide a variety of aerial feature actions to provide dynamic and intelligent motion over time that manages weather conditions to provide one or more practical benefits, such as liquid water, electricity, shade, or rain-bearing clouds.

The positioning system 310 can employ any number of controllers, microprocessors, or other programmable circuitry that conduct various operations, which can be generally characterized as a processor 340. An example processor 340 can translate assorted input criteria into one or more strategies that result in water, shade, and/or electricity. Although not required or limiting, input criteria may provide weather conditions logged by the positioning system 310, current real-time weather conditions, model data from other positioning systems, and predicted future weather forecasts to generate and maintain operational parameters and sequences of aerial feature actions that intelligently convey a selected purpose, such as harvesting atmospheric water, seeding rain-producing clouds, reducing surface temperature via shade, and/or generating electricity with aerial feature motion.

While the processor 340 may generate and execute one or more aerial feature actions in real-time, some embodiments store each proactively generated strategy in local memory 350 to be efficiently recalled and carried out in response to at least one operational trigger being met. It is noted that various software, firmware, and other information may be stored in memory remote to the positioning system 310 and communicated to the system processor 340 via wired and/or wireless communication pathways upon request. The proactive generation and local storage of several different operational strategies that respectively prescribe aerial feature operating parameters and actions over time can ensure efficient weather management responsive to detected conditions, which can produce more robust weather yields or surface temperature stability.

Through the evaluation of various input criteria individually and/or collectively, the positioning system 310 can sequentially, or concurrently, generate a series of aerial feature actions, thresholds, elevations, and reactions to detected conditions that are intended to achieve a purpose, which can be characterized as a strategy. The proactive generation of a strategy for a purpose can be enhanced over time with adaptation from one or more prescribed aspects in response to changing conditions, forecasts, and/or performance of an aerial feature. It is noted that the assorted strategies generated by the positioning system 310 can be populated with activity and thresholds generated by one or more positioning system 310 modules. A module may be any assortment of circuitry, such as a system-on-chip (SOC), application specific integrated circuit (ASIC), or other programmable semiconductor, that operates to produce aerial feature activity that is carried out by the system processor 340 in response to detected, or predicted, weather conditions.

The operation of the processor 340 alone can provide aerial feature elevations for various weather management purposes. It is contemplated that an elevation module 810 of the positioning system 310 determines the altitude above an underlying surface that best produces a selected theme in view of current, detected weather conditions and/or forecasted future weather conditions. The elevation module 810 can provide different elevations for a single strategy as well as for strategies with different weather management purposes. For example, the elevation module 810 can evaluate the presence of water vapor at different altitudes and calculate the likelihood of producing appreciable volumes of electricity, liquid water, or rain-producing clouds above a predetermined threshold volume. Such evaluation and calculation can allow the elevation module 810 to populate a strategy with an elevation that gives the best opportunity to satisfy a threshold volume of electricity or water based on current and/or forecasted weather conditions.

It is noted that the elevation module 810 may also evaluate different aerial feature altitudes to produce a desired size and shape of shade along with shade motion over time to provide intelligent surface temperature stability. The evaluation of how aerial feature motion over time will result in the production of water, electricity, or shade can further be conducted by a motion module 820 of the positioning system 310. Much like the elevation module 810, the motion module 820 can consider a multitude of different aerial feature actions over time to produce the selected weather management purpose (water/shade/electricity) for the current and/or predicted future weather conditions. As a non-limiting example, a water harvest strategy can be populated with large slow motion by the motion module 820 in high humidity, high barometric pressure conditions and small, quick circular motion in low humidity conditions. Another example populates a seed strategy with motion that promotes cloud formation towards surface regions where rain is wanted.

For motion prescribed in a shade strategy, the motion module 820 may determine movement at a select elevation that best produces intelligent shade that does not inhibit the natural rhythms of humans and plants. Operation of the seed module 830 of the positioning system 310 can further expound on the prescribed aerial feature activity from the elevation module 810 and motion module 820 by evaluating when and how atmospheric water vapor can be condensed into rain producing clouds. The seed module 830 may further prescribe aerial feature activity to seed clouds with minimal risk of severe weather, which can be characterized as flooding rain, winds over a threshold speed, or lightning frequency over a threshold amount, based on one or more input criteria.

The positioning system 310 may employ a harvest module 840 to determine when and how aerial features can operate to condense and collect atmospheric water vapor as liquid water. The harvest module 840 can prescribe a variety of activities to promote condensation of water vapor on the surfaces of an aerial feature followed by activities that promote the travelling of liquid water towards, and down, the aerial feature tether to a ground-based reservoir. It is contemplated that the harvest module 840 populates a harvest strategy with multiple different series of activities that operate in succession to collect atmospheric water vapor as liquid water after traveling down an aerial feature tether to a reservoir.

Various embodiments of the positioning system 310 engage multiple different strategies concurrently with one or more aerial features. For instance, the processor 340 can change prescribed activity in one strategy based on changes to weather forecasts while another strategy is being actively conducted to produce a weather management purpose. The ability to stack multiple separate aerial features on a single tether further allows different strategies to be concurrently conducted to convey different weather management purposes. As such, any strategy can be employed individually or simultaneously with more than one aerial feature.

It is contemplated that a shade strategy generated by a shade module 850 of the positioning system 310 can be carried out concurrently with another strategy, such as electricity generation or cloud seeding, with one or more aerial features. The shade module 850 can evaluate current weather conditions along with forecasted future conditions to determine how aerial feature movement can produce shade to prevent increases in surface temperature without degrading naturally occurring rhythms associated with sunlight. That is, the shade module 850 can prescribe aerial feature activity that results in dynamic shade intensity and moments of sunshine for surface regions without raising surface temperatures or preventing sunlight continuously for prescribed amounts of time, such as thirty minutes, one hour, or twelve hours.

FIG. 9 is a flowchart of an example weather management routine 900 that can be conducted with the positioning system of FIG. 8 as part of a weather management system, as shown in FIGS. 2-7 and discussed above. The weather management routine 900 can begin with the launching of at least one aerial feature, such as a kite, with a ground-based tether in step 910. The launching of an aerial feature in step 910 can involve the unpowered, or powered, release of at least one tether from a positioning system with one or more aerial features physically attached to a tether.

While a positioning system can deploy one or more aerial features with at least one connected tether for any reason and for any amount of time, various embodiments utilize the airborne aerial feature(s) for one or more purposes. It is contemplated that the positioning system has a variety of strategies stored locally in memory and available for execution in response to a weather condition trigger and/or manual selection of an aerial feature weather management purpose. Decision 920 evaluates assorted input criteria with a positioning system to determine how an aerial feature is to be utilized to manage weather conditions.

Although not required or limiting for purposes for a deployed aerial feature, elevated water vapor can be harvested in step 930 by executing a preexisting harvest strategy that promotes condensation of water vapor on the surface of an aerial feature and subsequent collection of liquid water at a ground-based reservoir via the tether. The activity of the harvest strategy executed in step 930 can, in some embodiments, prescribe elevations, movement, speed, and distance from the positioning system in an effort to harvest as much atmospheric water as possible given the weather conditions, such as wind, temperature, humidity, and barometric pressure.

The positioning system, in other embodiments, can choose to execute a seeding strategy in step 940 to transform atmospheric water vapor into clouds. The seeding strategy can prescribe aerial feature activity that promotes cloud density that is more likely to produce appreciable volumes of water that reach the ground and/or bodies of water than less dense clouds. A positioning system, in carrying out a seeding strategy in step 940, can engage atmospheric regions of water vapor with seeding nodes positioned on an aerial feature to promote the formation, and intensity, of clouds. As a result, the rain can be created, or enhanced, in regions that would otherwise not receive shade from clouds and/or appreciable rain. It is contemplated that the seeding strategy of step 940 involves promoting development of rain producing clouds in an effort to decrease the severity of thunderstorms and/or risk of flooding at selected surface locations.

The ability to control the elevation, direction, and speed of an aerial feature with a positioning system allows for directed feature motion that can be harnessed to generate electricity. Decision 920 can choose to direct aerial feature activity to generate electricity in step 950 by executing a motion strategy with the positioning system. It is noted that electricity can be generated, and the motion strategy can be carried out in step 950, in combination with another weather management purpose, such as harvesting water or seeding clouds. Other contemplated embodiments of the execution of step 950 involve stacked aerial features each affixed to a common tether that has induced movement, according to the motion strategy, that concurrently generates electricity while providing another weather management purpose with one or more of the other tethered aerial features.

Another potential weather management purpose capable of being conducted is the shading of selected surface regions with one or more aerial features in step 960. Execution of a shade strategy in step 960 can respond to sensed weather conditions, prescribed timing, and/or forecasted future surface conditions by positioning at least one aerial feature to block light rays from reaching the ground and/or body of water. Various embodiments of step 960 conduct a shade strategy with the positioning system to reflect the sun's rays away from a selected sur location while moving in a manner that provides varying sunlight intensity for the surface location over time. That is, execution of a shade strategy in step 960 can conduct intelligent aerial feature activity to provide dynamic shade of changing intensity over time so that the natural rhythms and reactions of humans and/or plants. For instance, a shade strategy can allow sufficient photosynthesis in plants and circadian rhythms in humans while reducing surface temperature volatility and/or maximum daytime temperatures experienced in the selected surface region.

At the conclusion of any strategy chosen by decision 920, routine 900 returns to an evaluation of the weather management purpose of an aerial feature. As such, a single aerial feature can sequentially be used for different weather management purposes without alteration or being brought to the ground, or water-based vessel, and relaunched. Accordingly, a positioning system can conduct the weather management routine 900 to provide a diverse variety of weather manipulation and harnessing results from a single launch in step 910. The addition of aerial features from a single positioning system, or multiple separate positioning systems, allows for concurrent weather management purposes that can provide multiple different benefits through the execution of the assorted strategies stored in a positioning system.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system for manipulating weather comprising:
a positioning system; and
an aerial feature tethered to the positioning system, the positioning system steering the aerial feature to position the aerial feature to react to naturally occurring weather conditions to alter surface conditions using a strategy generated by the positioning system, wherein the aerial feature, when positioned based on the strategy, is configured to perform at least one of: seeding a cloud, generate shade on a predetermined surface location, and collect water from the atmosphere.

2. The system of claim 1, wherein the aerial feature is an unpowered kite.

3. The system of claim 1, wherein the positioning system is positioned on a ground level and comprises a processor and local memory.

4. The system of claim 3, wherein the strategy is stored in the local memory prior to execution by the processor.

5. The system of claim 1, wherein the aerial feature has a first node separated on a surface of the aerial feature from a second node, each node comprising a silver iodide material.

6. The system of claim 5, wherein each node remains attached to the surface of the aerial feature during seeding of the cloud.

7. The system of claim 5, wherein the first node is on a top surface of the aerial feature and the second node is on a bottom surface of the aerial feature, the top surface facing an opposite direction than the bottom surface.

8. The system of claim 1, wherein the aerial feature comprises a steering winch.

9. The system of claim 1, wherein the aerial feature comprises a sensor connected to a kite control unit positioned opposite the positioning system along the tether.

10. The system of claim 1, wherein the tether is hollow and connected to a reservoir for liquid water.

11. A method comprising:
launching an aerial feature to an elevation, the aerial feature tethered to a positioning system;
generating, with the positioning system, a motion strategy to direct aerial feature movement over time to induce a surface condition selected by the positioning system; and
executing, with the positioning system, the motion strategy over time to steer the aerial feature and react with naturally occurring weather conditions to provide the selected surface condition.

12. The method of claim 11, wherein the motion strategy prescribes a pattern of motion over time for the aerial feature to generate electricity with a generator of the positioning system.

13. The method of claim 11, wherein the motion strategy prescribes a pattern of motion over time for the aerial feature to condense atmospheric water vapor into liquid water on a surface of the aerial feature.

14. The method of claim 13, wherein the motion strategy prescribes aerial feature activity to promote movement of liquid water from a canopy portion of the aerial feature to a tether, the tether connecting the aerial feature to the positioning system.

15. The method of claim 11, wherein the motion strategy prescribes aerial feature motion over time to provide dynamic intensities of sunlight to a selected ground region.

16. The method of claim 15, wherein the dynamic intensities of sunlight correspond with different amounts of sunlight reaching the selected ground region for predetermined times set in the motion strategy.

17. The method of claim 11, wherein the motion strategy prescribes changing elevation of the aerial feature over time.

18. A method comprising:
launching an aerial feature including a first lift member and a second lift member, each lift member tethered to a positioning system;
generating, with the positioning system, a motion strategy, the motion strategy directing movement of first lift member over time to induce a first surface condition and movement of the second lift member over time to induce a second surface condition, the first surface condition and second surface condition being different; and
executing, with the positioning system, the motion strategy over time to steer the respective lift members to position the aerial feature to react with naturally occurring weather conditions to provide the first surface condition and second surface condition concurrently.

19. The method of claim 18, wherein the first lift member collects atmospheric water with the motion strategy while the second lift member moves over time in accordance with the motion strategy to promote formation of rain-bearing clouds.

20. The method of claim 18, wherein the first lift member provides shade to a selected ground region while the second lift member moves over time in accordance with the motion strategy to generate electricity with the positioning system.
